(19) United States
(12) Patent Application Publication
(10) Pub. No.: US 2007/0194508 A1
(43) Pub. Date: Aug. 23, 2007

(54) SPRING FABRICATED FROM A TUBE

(76) Inventor: Henry R. Bucciero, Harper Woods, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/677,234

(22) Filed: Feb. 21, 2007

Related U.S. Application Data
(60) Provisional application No. 60/775,236, filed on Feb. 21, 2006.
(60) Provisional application No. 60/819,785, filed on Jul. 10, 2006.

(51) Int. Cl. F16F 1/00

(52) U.S. Cl. 267/182; 267/70

(57) ABSTRACT

A compression spring is formed from an elongated tube by cutting slots at spaced intervals along the length of the tube, leaving only anchors of a small perimeteral extent connecting the beams formed by the remaining tube stock between each adjacent pair of slots. Adjacent slots are formed from diametrically opposed sides of the tube leaving one line of anchors on each side of the resultant spring.

### CROSS-REFERENCE TO RELATED APPLICATIONS

This application claims priority of U.S. Provisional Patent Application Ser. No. 60/775,236 filed Feb. 21, 2006, and Ser. No. 60/819,785 filed Jul. 10, 2006, which are incorporated herein by reference.

### FIELD OF THE INVENTION

This invention relates to compression springs and more particularly to a compression spring formed from a tube with sections of the tube wall material removed at regularly spaced intervals along the length of the tube.

### BACKGROUND OF THE INVENTION

Most springs are formed by toroidally winding an elongated wire. These springs are difficult to manufacture when the spring index, that is the value of the mean coil diameter divided by the wire diameter, is either very large or very small. They are also difficult to fabricate when the load or dimensional tolerances are critical. Additional problems occur when the application is such that no visible coiling marks can be present on the finished spring.

### SUMMARY OF THE INVENTION

The present invention is accordingly directed toward a compression spring which overcomes these deficiencies of typical coiled springs.

The present invention is directed toward a compression spring formed of a closed cross section tube, which may be circular, square, hexagonal or the like, with sections of the wall material being removed at regularly spaced intervals along the length of the tube, to leave anchors of a small perimeteral extent in the wall of the tube connecting the fully circumferential beam sections on opposed sides of each removed section.

In one embodiment of the invention, which will subsequently be disclosed in detail, the removed sections extend normally to the tube axis and are formed in alternative directions so that the unremoved perimeteral sections, i.e. the anchors, are disposed on alternate, diametrically opposed sides of the tubular structure.

Springs formed in accordance with the present invention are well suited for use as die springs, because of their rectangular ends. Die springs are generally divided into four load designations: light, medium, heavy and extra-heavy, along with common outside and inside diameters in free lengths. Because all four load designations have common interior dimensions, i.e. outside and inside diameters in free lengths, one tube size can be used to fabricate all the parts in the four load ranges having the same physical dimension with the exception of the number and sizes of the multiple beams which would be used to create the load variations.

In addition, because the flexing members are virtual beams, component stress levels can be correlated to the fabricating material's minimum tensile strength rater than approximately 50% of the minimum tensile strength required by all current toroidal die spring designs. This contributes to lower costs and improved designs.

### BRIEF DESCRIPTION OF THE DRAWINGS

Other objects, advantages and applications of the present invention will be made apparent in connection with the description of the accompanying drawings, in which:

FIG. 1 is a perspective view of a cylindrical spring formed in accordance with my present invention;

FIG. 2 is a side view of the spring of FIG. 1;

FIG. 3 is an end view of the tube of FIG. 1; and

FIG. 4 is a perspective view of a spring fabricated in accordance with the present invention from a rectangular tube.

### DETAILED DESCRIPTION OF A PREFERRED EMBODIMENT

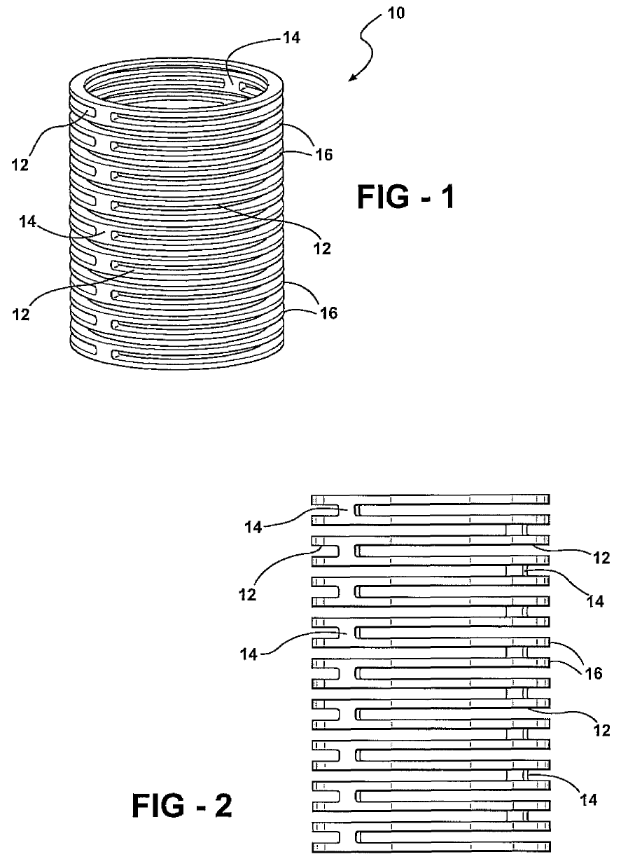

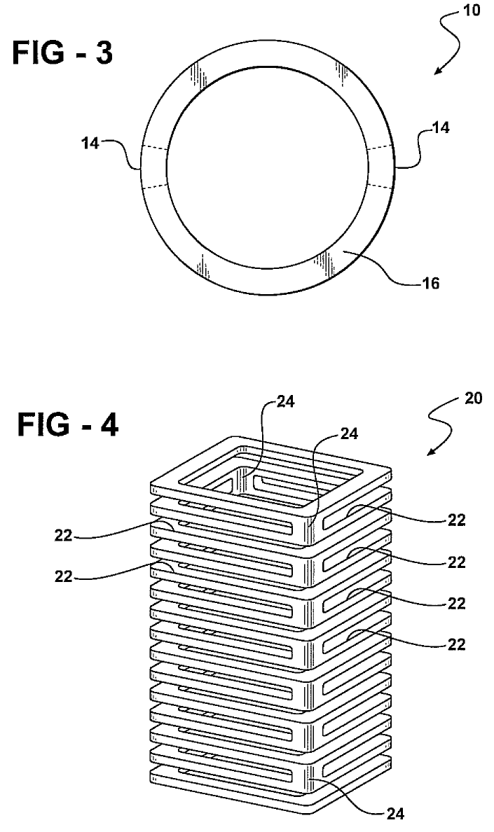

Referring to FIGS. 1-3, a compression spring formed from a cylindrical tube in accordance with the present invention is illustrated. The spring, generally indicated at 10, is formed from a round tube of metal, preferably a steel alloy of the type used to form coiled springs. Slots 12 are then formed at spaced intervals along the length of the tube in a plane perpendicular to the central axis of the tube. In the preferred embodiment of the invention, the slots have widths approximately equal to the width of the anchors 14 left in the wall of the tube after the slot is formed. The slots may preferably extend for approximately 320 to 350 degrees around the perimeter of the tube, leaving only the short anchors 14 extending between adjacent remaining beams 16.

Adjacent slots 12 are cut from alternate sides of the tube so that the anchors connecting one pair of beams 16 are diametrically opposed to the anchors connecting each of the two connected beams 16 with the next adjacent beam. Thus, any one pair of adjacent beams are connected at one end by a common anchor and at the diametrically opposite side of the spring 10, each of the beams of the pair is connected by a different anchor to another beam. One set of anchors 14 extends along one side of the spring, connecting alternate beams, and another set of anchors 14 extends along the diametrically opposed side of the spring, connecting the beams which are unconnected on the opposite side.

The slots 12 may be removed from the tube stock by milling, grinding, laser cutting, electrolytic removal, or any other appropriate process.

The resulting spring 10 acts as a compression spring when forces are exerted on its opposite ends, by flexure of the beams 16 as a result of forces transmitted through the anchors 14.

FIG. 4 illustrates a spring, generally indicated at 20, formed from a square tube by slots 22 formed at spaced intervals along the length of the tube, leaving only one corner uncut to act as anchors 24. The slots 22 are cut from alternating sides of the tube, leaving four-sided beams 26 connected at one end to a beam in a first direction along the axis of the tube by one anchor 24 and at the opposite side of the tube connected to a beam in the opposite direction along the axis of the tube by a second anchor 24.

1. A compression spring comprising:
a tubular member having an elongated central axis;
a plurality of slots formed through the thickness of the tube at regular intervals along the axis so as to form beams extending along the major portion of the circumference of the tube connected at their ends by only relatively narrow axially extending anchors, with alternate slots along the tube axis being formed from opposite sides of the tubular member to form a first series of anchors extending along one side of the tubular member, and a second series of anchors extending along the opposite side of the tubular member.

2. The spring of claim 1 in which the tubular member is cylindrical.

3. The spring of claim 1 in which the tubular member is square.

4. The method of forming a compression spring from a tube, comprising:
cutting slots transverse to the tube central axis extending through the major portion of the tube perimeter, leaving axially extending anchor sections at spaced intervals along the length of the tube, with alternate slots being cut from opposite sides of the tube, leaving a series of beams connected at one end to an anchor extending in a first axial direction and at the opposite end to an anchor extending in the opposite axial direction.

5. The method of claim 4 in which the cutting is performed by milling.

6. The method of claim 4 in which the cutting is performed by grinding.

7. The method of claim 4 in which the cutting is performed by laser removal.
